(19) United States
(12) Patent Application Publication
(10) Pub. No.: US 2016/0365772 A1
(43) Pub. Date: Dec. 15, 2016

(54) HYDRAULIC PUMP WITH ELECTRIC GENERATOR

(71) Applicant: SPX FLOW, INC., Charlotte, NC (US)

(72) Inventors: Michael T. LANDRUM, Rockford, IL (US); Dwight E. Booth, Milton, WI (US)

(21) Appl. No.: 15/176,865

(22) Filed: Jun. 8, 2016

Related U.S. Application Data
(60) Provisional application No. 62/174,242, filed on Jun. 11, 2015.

(51) Int. Cl. H02K 7/18; F02B 63/06; F02B 63/04

(52) U.S. Cl. CPC H02K 7/1815; F02B 63/042; F02B 63/06

(57) ABSTRACT

A hydraulic pump is provided. The pump includes: a pump shaft adapter configured to rotate and operate the hydraulic pump thereby; a magneto operatively connected to the pump shaft adapter; conductors extending from the magneto connecting the magneto to a power outlet to provide electricity generated by the magneto to the power outlet; and a hydraulic pump housing enclosing both the hydraulic pump and the magneto. A method of generating electricity may be provided. The method includes: adapting a pump shaft to include an attaching structure; attaching a magneto to the attaching structure; and configuring the magneto to generate electricity when the pump shaft rotates.

This application claims the benefit of a provisional U.S. patent application entitled HYDRAULIC PUMP WITH ELECTRIC GENERATOR, having a Ser. No. 62/174,242, filed Jun. 11, 2015. The disclosure of this application is hereby incorporated by reference in its entirety.

### FIELD OF THE INVENTION

The present invention relates generally to hydraulic pumps. More particularly, the present invention relates to a hydraulic pump configured to use the rotating shaft of a prime mover configured to operate the pump to also generate electric power.

### BACKGROUND OF THE INVENTION

Hydraulic pumps are often operated at construction or other work sites that do not always have access to electric power. The hydraulic pumps may be operated by a variety of different prime movers. For example, gasoline motors, diesel motors, pneumatic motors, natural gas motors, propane powered motors or any other type of motor may be used to drive a hydraulic pump. In many instances, the prime mover may provide a rotating shaft to the hydraulic pump. The hydraulic pump then has a shaft that connects to the output shaft of the prime mover in order to operate the hydraulic pump.

In some instances, it may be useful to have some electric power available in addition to the mechanical shaft power provided by the prime mover. For example, certain hydraulic valves may be electrically operated or controlled by electronic controller that runs on electricity. In other instances various valves a be moved by electric actuators. In still other instances, other devices may run on electricity forming a desire for electric power to be generated by the energy or rotating shaft of the prime mover. In some instances, generators may not be used to generate electric power because of arcing or sparks that may occur within the generator. For example, in mines where flammable gases may accumulate such generators should not be used. Accordingly, it is desirable to provide a method and apparatus that can use the rotating shaft provided by a prime mover to run both a hydraulic pump and generate electric power.

### SUMMARY OF THE INVENTION

The foregoing needs are met, to a great extent, by the present invention, wherein in one aspect an apparatus is provided that in some embodiments uses a rotating shaft powered by a prime mover to run both a hydraulic pump and generate electricity.

In accordance with one embodiment of the present invention, a hydraulic pump is provided. The pump includes: a pump shaft adapter configured to rotate and operate the hydraulic pump thereby; a magneto operatively connected to the pump shaft adapter; conductors extending from the magneto connecting the magneto to a power outlet to provide electricity generated by the magneto to the power outlet; and a hydraulic pump housing enclosing both the hydraulic pump and the magneto.

In accordance with another embodiment of the present invention, a method of generating electricity is provided. The method includes: adapting a pump shaft to include an attaching structure; attaching a magneto to the attaching structure; and configuring the magneto to generate electricity when the pump shaft rotates.

In accordance with yet another embodiment of the present invention, a hydraulic pump is provided. The pump may include: a means for transmitting mechanical power configured to rotate and operate the hydraulic pump thereby; a means for generating electrical power operatively connected to the means for transmitting mechanical power; means for transmitting electrical power extending from the means for generating electrical power to a power outlet to provide electricity generated by the means for generating electrical power to the power outlet; and a hydraulic pump housing enclosing both the hydraulic pump and the means for generating electrical power.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a front view of a motorized hydraulic pump according to an embodiment of the present disclosure.

FIG. 2 is a front view of a motorized hydraulic pump with part of the housing removed in order to show internal components according to embodiments of the present disclosure.

FIG. 3 is a partially exploded view of the motorized hydraulic pump of FIG. 2.

FIG. 4 is a perspective view of an adapted pump shaft in accordance with an embodiment of the present disclosure.

FIG. 5 is a partially broken away top view of the adapted pump shaft of FIG. 4.

FIG. 6 is a partial, enlarged cross-sectional view of a portion of the motorized hydraulic pump.

FIG. 7 is a partial, enlarged cross-sectional view of a portion of the motorized hydraulic pump.

FIG. 8 is a perspective, partial, enlarged cross-sectional view of a portion of the motorized hydraulic pump according to an embodiment of the disclosure.

FIG. 9 is a schematic wiring diagram of the motorized hydraulic pump.

### DETAILED DESCRIPTION

The various embodiments in accordance with the present disclosure will now be described with reference to the drawing figures, in which like reference numerals refer to like parts throughout. An embodiment in accordance with the present disclosure provides a motorized hydraulic pump. The motorized hydraulic pump is driven by a prime mover. The prime mover provides energy to run the hydraulic pump in the form of a rotating shaft. In addition to performing pumping operations, the hydraulic pump is capable of generating electricity. Electricity may be used for a variety of purposes including operating hydraulic valves that may receive pressurized hydraulic fluid from the hydraulic pump.

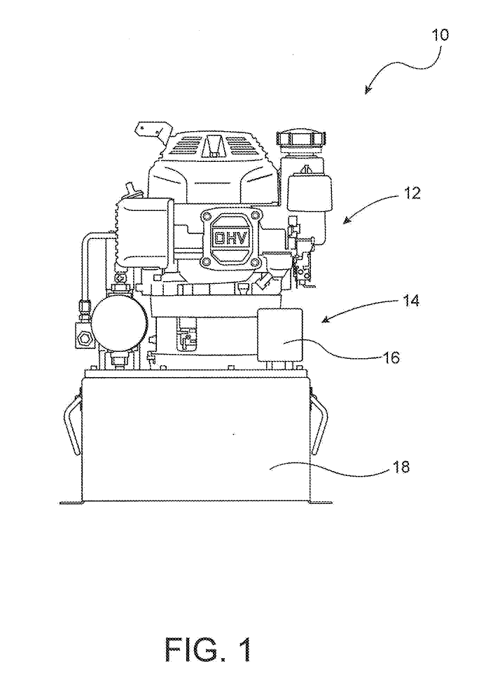

FIGS. 1, 2, and 3 illustrate a motorized hydraulic pump 10 in accordance with the present disclosure. The motorized hydraulic pump 10 includes a prime mover 12. The prime mover 12 illustrated in FIGS. 1-3 includes a gasoline reciprocating engine. However, in other embodiments, a variety of prime movers 12 may be used. For example, the prime mover 12 may be a pneumatic motor, a hydraulic motor, an engine running on propane or natural gas or any other motor that is configured to rotate a shaft.

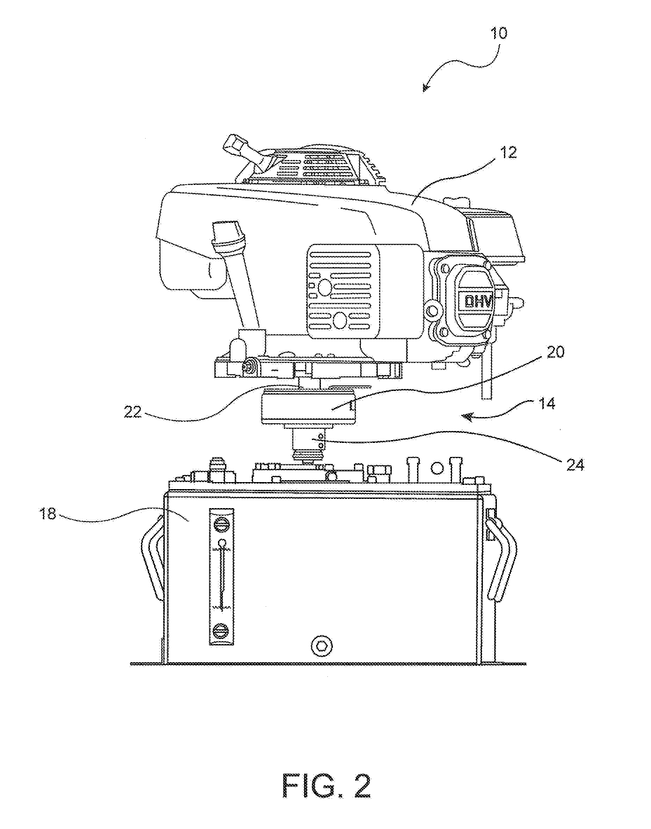

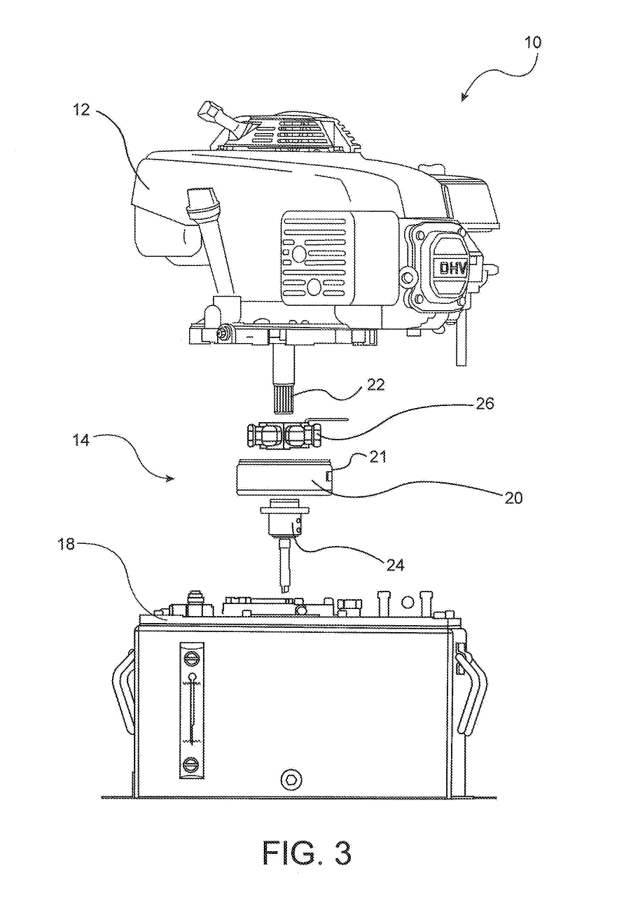

FIGS. 1-3 illustrate a power generation assembly 14. The power generation assembly 14 is located in between the prime mover 12 and the hydraulic pump 18. The power generation assembly 14 shown in FIG. 1 is covered by a housing 16. In some embodiments, the housing 16 is part of the hydraulic pump 18 such that the power generation assembly 14 is contained within the housing 16 of the hydraulic pump 18. The housing 16 is removed (or, at least, partially removed) in FIGS. 2 and 3 to better illustrate the parts of the power generation assembly 14.

FIG. 2 is an assembled view of the motorized hydraulic pump 10 with the housing 16 removed. FIG. 3 is a partially exploded view of the motorized hydraulic pump 10 where the prime mover 12 and the hydraulic pump 18 are intact but separated from each other. As shown in FIGS. 2 and 3, the prime mover 12 has a drive shaft 22 that extends down below the prime mover 12 toward the power generation assembly 14. The power generation assembly 14 may be a magneto 20. The magneto 20 may include a rotor 21 and a stator assembly 26 which will be discussed in further detail later below. The magneto 20 is attached to an adapted pump shaft 24 which is also connected to the drive shaft 22 of the prime mover 12. In some embodiments, it is the adapted pump shaft 24 which is attached to the power generation assembly 14 and also drives the hydraulic pump 18.

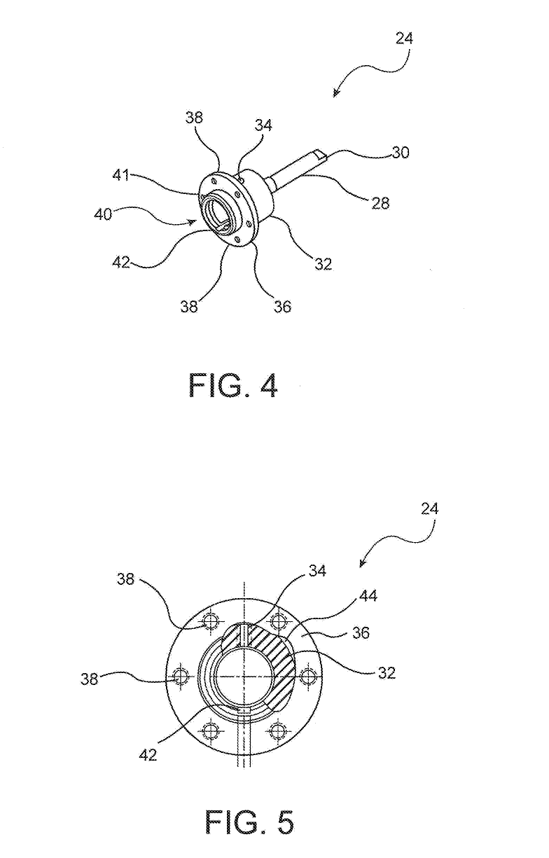

FIG. 4 is a perspective view of the adapted pump shaft 24. FIG. 5 is an end view of the adapted pump shaft 24 having a broken out portion 44 which allows better illustration of some of the aspects of the adapted pump shaft 24 described below. With respect to FIGS. 4 and 5, the adapted pump shaft 24 includes a shaft portion 28 terminated at one end with a flat end portion 30.

In some embodiments, the flat end portion 30 is configured to engage with components of the hydraulic pump 18 to drive the hydraulic pump 18 (See FIGS. 1-3 for the hydraulic pump 18). The adapted pump shaft 24 may have a larger diameter portion 32 which has a larger diameter than the shaft portion 28. The larger diameter portion 32 may include a set screw hole 34 which, in some embodiments, may be threaded. The screw hole 34 may be used to allow a screw to enter the screw hole 34 and urge against the shaft 22 to better keep it in place within the adapted pump shaft 24.

The adapted pump shaft 24 may be particularly adapted in order to both drive the hydraulic pump 18 and the rotor 21. In this regard, the adapted pump shaft 24 may include attaching structure such as, but not limited to, a flange 36 having connecting holes 38. The flange 36 and connecting holes 38 may allow the adapted pump shaft 24 to attach to the rotor 21 which will be described in additional detail below. The adapted pump shaft 24 may also define an opening 40. In some embodiments, the opening 40 may be encompassed about by a raised lip portion 41. Furthermore, in some embodiments, the opening 40 may also include a keyway 42 which may be dimensioned to engage with a key located on the drive shaft 22 in order to provide a positive rotational connection between the drive shaft 22 coming from the prime mover 12 and the adapted pump shaft 24.

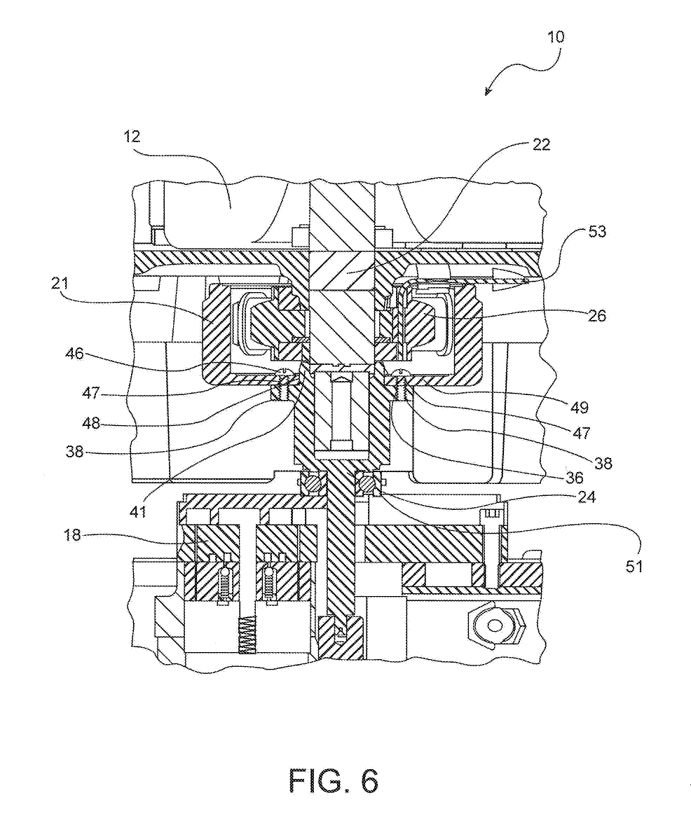

FIG. 6 is a partial cross-sectional view of the motorized hydraulic pump 10. The drive shaft 22 is shown extending from the prime mover 12 through the rotor 21 and stator assembly 26 and connecting to the adapted pump shaft 24. The attaching bolts or fasteners 46 are shown extending through attaching holes 47 in the rotor 21 and the connecting holes 38 in the adapted pump shaft 24. In this manner, the flange 36 of the adapted pump shaft 24 is secured against the mounting surface 49 of the rotor 21.

The rotor 21 has a receiving hole 48. In some embodiments, the receiving hole 48 has been modified or formed so that it is dimensioned to permit the raised lip portion 41 of the adapted pump shaft 24 to extend into the rotor 21. In some embodiments, the receiving hole 48 is modified from a tapered shape common to off-the-shelf parts and is squared off as shown. The adapted pump shaft 24 sits upon a bearing 51 and extends into the hydraulic pump 18.

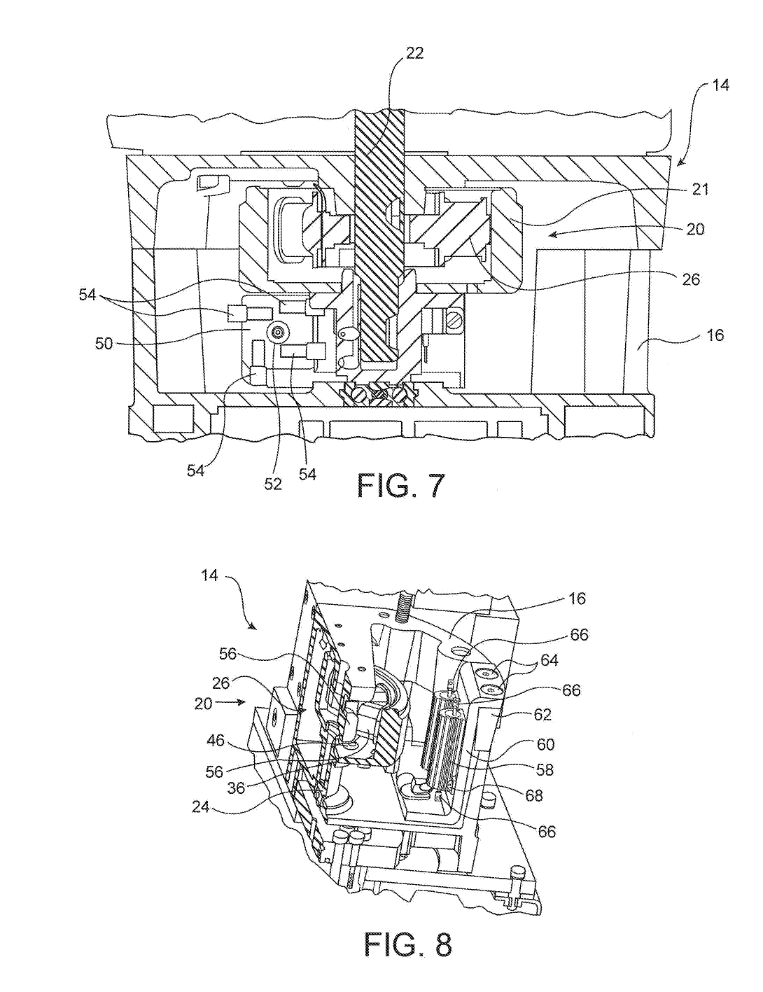

FIG. 7 is a partial enlarged cross-sectional view of the power generation assembly 14. The rotor 21 and the stator assembly 26 are shown with the drive shaft 22 extending through both the rotor 21 and the stator assembly 26. A rectifier 50 is illustrated as attached to the housing 16. The rectifier 50 is secured to the housing 16 by holding screw 52. In other embodiments the rectifier 50 may be mounted in a different manner than what is shown and described herein while still being in accordance with the disclosure. The rectifier 50 may include various attachment points 54 for receiving wires 53 extending out of the stator assembly 26 (as seen in FIG. 6).

As shown in FIG. 8 which is a partial cross-sectional perspective view of the power generation assembly 14 the magneto 20 operates by a stator assembly 26 having coils 56 made of coiled wires or conductors remaining stationary while the rotor 21 including magnets rotates around the coils 56. In this manner, electricity is generated within the conductors in the coils 56 and the electricity flows out of the wires 53 as shown in FIG. 6. Magnetos 20 are well known and will not be described in additional detail here. One of ordinary skill in the art after reviewing this disclosure will understand that magnetos 20 having different construction than that shown and described herein may be used in accordance with the present disclosure.

In a nonlimiting example embodiment, the magneto rotor 21 and stator assembly 26 may be obtained from Universal Parts 7300 Bryan Dairy Road, Seminole, Fla., 33777. The rotor 21 is identified by part number 164-191 and the stator assembly 26 is identified by part number 164-289.

In order to make the power generated by the magneto 20 more suitable for use the electricity may first be run through the rectifier 50. In some instances, the rectifier may be one provided by FALGOR having part number FB2506 or a rectifier 21 provided by TAITRON (TCI) having part number GBPC25-06. It should be understood that these rectifiers 50 are meant to be examples that are not limiting.

As shown in FIG. 8 resistors 58 may be mounted to a mounting bracket 60. The mounting bracket 60 may be mounted to a mounting portion 62 of the housing 16. The mounting bracket 60 may be equipped with a mounting bracket bolts 64. In some embodiments, the resistors 58 may be attached to the mounting bracket 60 by a resistor mounting bolt or fasteners 68. In other embodiments, the resistors 58 may be located in a different location and mounted differently than what is shown and still be used in accordance with the present disclosure. The resistors 58 may be equipped with leads 66 in order to provide attachment point to attach wires or other conductors to the resistors 58. In some embodiments, the lead 66 at the bottom of the resistor 58 will be an input lead and the lead 66 at the top of the resistor 58 will be an output lead 66.

In some embodiments, the resistors 58 are wirewound resistors capable of industrial power. They are aluminum housed and chassis mounted. A nonlimiting example resistor 58 that may be used is one provided by Vishay Dale identified by global part number RH050.

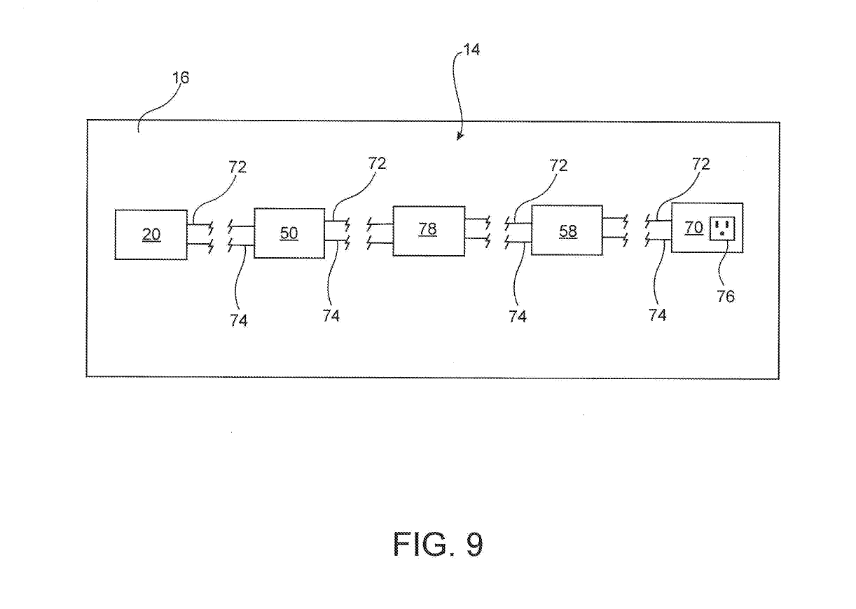

FIG. 9 illustrates an example schematic wiring diagram for the power generation assembly 14. The power generating assembly is shown contained within the housing 16. The magneto 20 generates electric power. The magneto 20 is conducted by wires 72 and 74 and the power is transmitted to the rectifier 50. Optionally, the power may be sent via wires 72 and 74 to an inverter 78 to stabilize the voltage level. Once the power is been rectified and optionally sent through the inverter 78, it is then transmitted by wires 72 and 74 to the resistors 58. At that point, the power is then outputted from the resistors 58 and transmitted by wires 72 and 74 to the terminal 70. The terminal 70 may include an outlet 76 which provides a place for users to access the power generated by the magneto 20.

The signal processing described above with respect to the power generation assembly 14 is not meant to be limiting but rather an example description. One of ordinary skill in the art after reviewing this disclosure will understand how to configure various components to achieve a desired level of signal processing. It should be understood that a variety of types of signal processing of the power generated by the magneto 20 may be accomplished in accordance with the disclosure.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A hydraulic pump comprising:
a pump shaft adapter configured to rotate and operate the hydraulic pump thereby;
a magneto operatively connected to the pump shaft adapter;
conductors extending from the magneto connecting the magneto to a power outlet to provide electricity generated by the magneto to the power outlet; and
a hydraulic pump housing enclosing both the hydraulic pump and the magneto.

2. The hydraulic pump of claim 1, wherein the power outlet is located on the hydraulic pump housing.

3. The hydraulic pump of claim 1, wherein the magneto includes a rotor connected to a flange located on the pump shaft adapter and the pump shaft adapter is operatively connected to a prime mover shaft extending from a prime mover wherein the rotor and pump shaft adapter are rotated by the prime mover shaft.

4. The hydraulic pump of claim 3, further comprising a stator located within the rotor.

5. The hydraulic pump of claim 4, wherein the stator includes coils.

6. The hydraulic pump of claim 3, wherein the prime mover is anyone of the following: a gasoline motor, a diesel motor, a natural gas powered motor, a propane powered motor; a pneumatic motor, and a hydraulic motor.

7. The hydraulic pump of claim 1, wherein the conductors are operatively connected to a rectifier located between the magneto and the power outlet.

8. The hydraulic pump of claim 7, wherein the conductors are operatively connected to a resistor connected between the rectifier and the power outlet.

9. The hydraulic pump of claim 1, wherein the pump shaft adapter includes a shaft portion, a large diameter portion being larger than the shaft portion, a flange having a greater diameter than the large diameter portion, and an extended lip portion projecting from the flange.

10. The hydraulic pump of claim 9, further including a keyway located in a chamber contained within the shaft adapter.

11. A method of generating electricity comprising:
adapting a pump shaft to include an attaching structure;
attaching a magneto to the attaching structure; and
configuring the magneto to generate electricity when the pump shaft rotates.

12. The method of claim 11, further comprising connecting a prime mover shaft to the pump shaft.

13. The method of claim 11, wherein the attaching structure includes a flange on the pump shaft defining the attaching holes.

14. The method of claim 11, further comprising attaching a rotor portion of the magneto to the attaching structure.

15. The method of claim 11, further comprising connecting an inverter to a conductor operatively connected to the magneto so that power generated by the magneto flows into the inverter.

16. The method of claim 15, further comprising connecting the inverter to a resistor so that power outputted from the inverter flows into the resistor.

17. The method of claim 16, further comprising operatively connecting the resistor to a power outlet.

18. The method of claim 11, further comprising covering the magneto, the pump shaft with a housing, and a hydraulic pump with a common housing.

19. The method of claim 11, further comprising attaching the pump shaft to a hydraulic pump.

20. A hydraulic pump comprising:
a means for transmitting mechanical power configured to rotate and operate the hydraulic pump thereby;
a means for generating electrical power operatively connected to the means for transmitting mechanical power;
means for transmitting electrical power extending from the means for generating electrical power to a power outlet to provide electricity generated by the means for generating electrical power to the power outlet; and
a hydraulic pump housing enclosing both the hydraulic pump and the means for generating electrical power.
